(19) United States
(12) Patent Application Publication
(10) Pub. No.: US 2002/0044452 A1
(43) Pub. Date: Apr. 18, 2002

(54) Removable auxiliary light for car

(76) Inventor: Ching-Hung Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/953,876

(22) Filed: Sep. 18, 2001

(51) Int. Cl. B60Q 1/26

(52) U.S. Cl. 362/528; 362/540; 340/468; 340/472

(57) ABSTRACT

An auxiliary light is adapted to removably mount on a body of a car at any selected position to function like a warning and decorating light. The removable auxiliary light for car includes a fixing seat for removably mounting onto the car, and a lamp connected to a top of the fixing seat. The lamp may also be directly coupled with a sidelight, a directional light, a stoplight or a reverse light of the car. A locating member may be turnably provided between the fixing seat and the lamp to allow angular adjustment of the lamp relative to the fixing seat via the locating member. The auxiliary light also has the function of testing a bank note for its genuineness.

### FIELD OF THE INVENTION

The present invention relates to an auxiliary light for car, and more particularly to an auxiliary light that could be removably mounted on a body of a car to function like a warning or decorating light.

### BACKGROUND OF THE INVENTION

To enhance the warning effect of the lights originally provided on a car, such as headlights, directional lights, etc., many car owners would usually add other types of lights to the car depending on actual needs. For example, a third stoplight and/or a second directional light may be mounted to warn a third party in a dark driving environment to secure a safe driving.

Moreover, many car owners also decorate their cars by mounting additional lights on the car at different positions.

Conventionally, these additional lights, either for enhanced warning effect or for decorating purpose, are fixedly mounted on the car and could not be easily dismounted. In some cases, the mounting and dismounting of these additional lights would even cause local destruction of the car body. As a result, these additional lights are not widely welcomed by most car owners.

### SUMMARY OF THE INVENTION

It is a primary object of the present invention to provide a removable auxiliary light for car to eliminate the drawbacks existing in the conventional auxiliary lights and to provide effective warning and decorating functions.

Another object of the present invention is to provide a removable auxiliary light for car that may be used to test a bank note for its genuineness.

To achieve the above and other objects, the auxiliary light for car according to the present invention mainly includes a fixing seat that is removably mounted onto the car, and a lamp connected to a top of the fixing seat. A locating member is provided between the fixing seat and the lamp to allow angular adjustment of the lamp relative to the fixing seat, so that the auxiliary light may be oriented toward different directions to provide good lighting and warning effect, particularly when the driver reverses the car in the night.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled sectional view of a removable auxiliary light for car according to the present invention;

FIG. 2 is a fragmentary perspective view showing the removable auxiliary light of FIG. 1 is mounted on a car;

FIG. 3 is a fragmentary side view showing the removable auxiliary light of FIG. 1 is mounted on a car;

FIG. 4 is a fragmentary side view of a car showing a lighting tube of the removable auxiliary light of the present invention mounted on the car is angularly adjustable relative to a fixing seat of the light; and

FIG. 5 is a rear view of a car showing the lighting tube of the removable auxiliary light of the present invention mounted on the car is angularly adjustable relative to the fixing seat of the light.

### DETAILED DESCRIPTION OF THE PREFERRED EMBODIMENTS

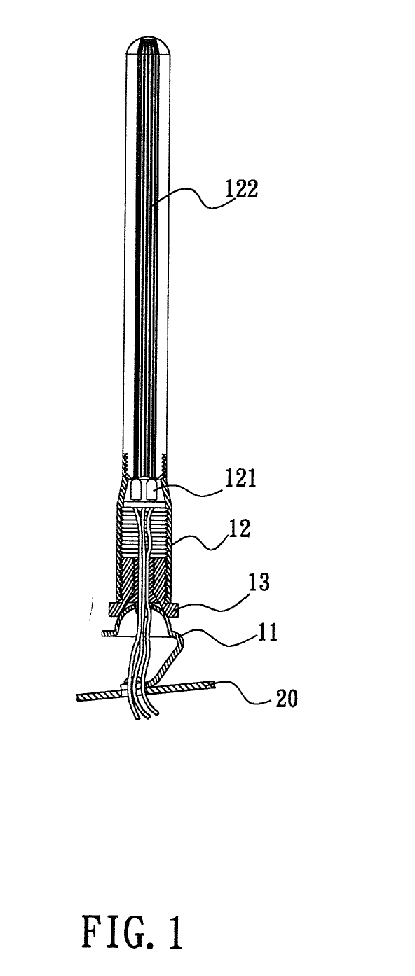

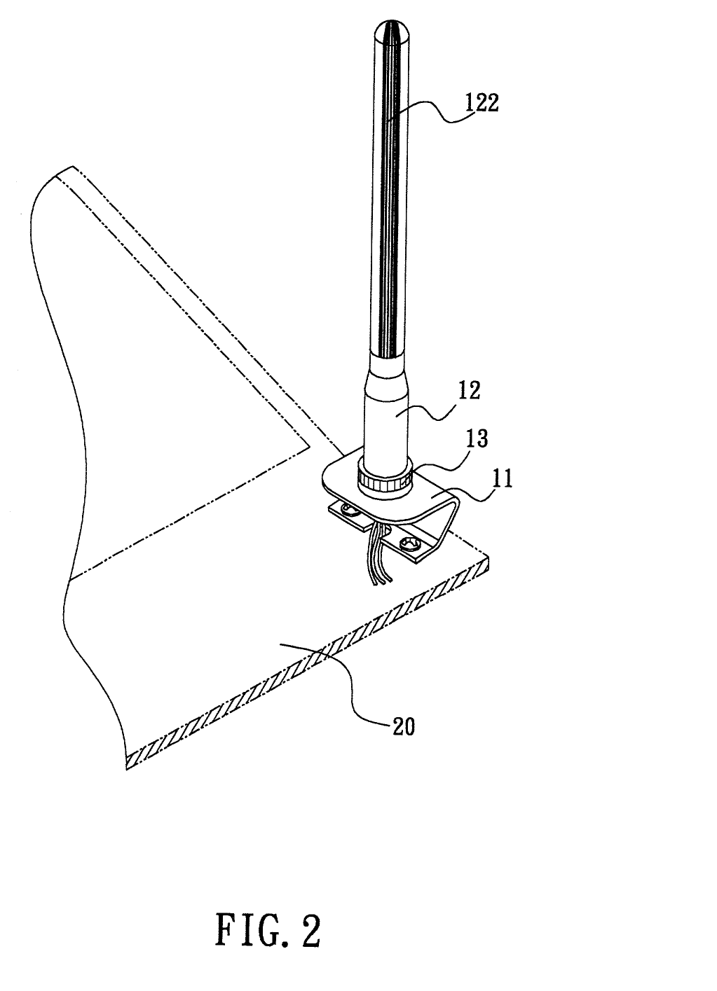

Please refer to FIGS. 1 and 2 that are assembled sectional view and perspective view, respectively, of a removable auxiliary light for a car according to the present invention. As shown, the light mainly includes a fixing seat 11 removably mounted on a carat a selected position with screws, clamping means or bonding agent, and a lamp 12 mounted on a top of the fixing seat 11.

The lamp 12 is movably connected to the fixing seat 11 to provide a light source. The lamp 12 is internally provided with at least one light-emitting element 121 and has a length of transparent lighting tube 122 connected to a top thereof, such that light emitted from the light-emitting element 121 is diffused via the lighting tube 122. The lamp 12 may also be otherwise connected at a lower end to a sidelight, a directional light, a stoplight or a reverse light of a car, enabling these lights originally provided on the car to have extended warning function.

The lighting tube 122 maybe made of a light transmissible material, so that light emitted from the light-emitting element 121 may pass through the lighting tube 122, allowing the entire light tube 122 to shine uniformly. For the auxiliary light to provide enhanced warning or decorating effect, the lighting tube 122 may be differently colored and/or shine intermittently. The lighting tube 122 may be connected to the top of the lamp 12 via an engaging mechanism provided at a joint of the lighting tube 122 and the lamp 12.

A locating member 13 is provided between the fixing seat 11 and the lamp 12, so that the lamp 12 is stably seated on the locating member 13 to locate above the fixing seat 11. The locating member 13 is so structured that it is turnable over the top of the fixing seat 11. Therefore, the lamp 12 and the lighting tube 122 connected thereto are angularly adjustable relative to the fixing seat 11 to point toward different directions, enabling a driver to use the auxiliary light of the present invention as an enhanced warning and lighting while reverses the car, particularly in the night. The auxiliary light of the present invention may also, of course, be used as a decoration of the car in normal times.

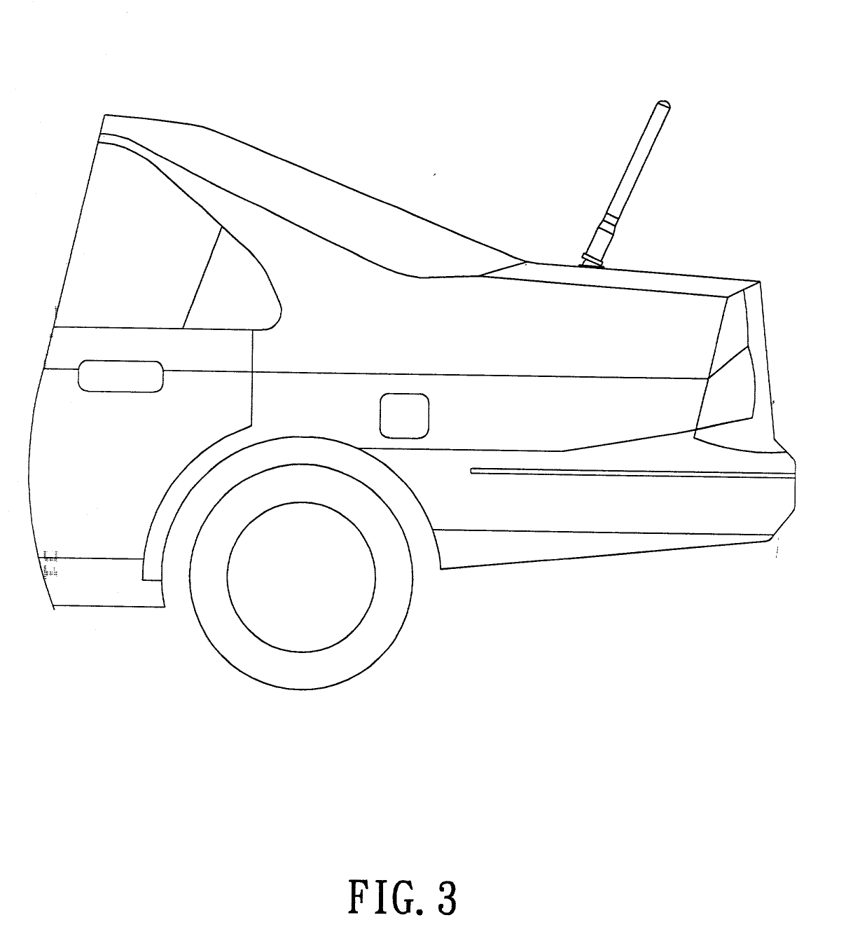

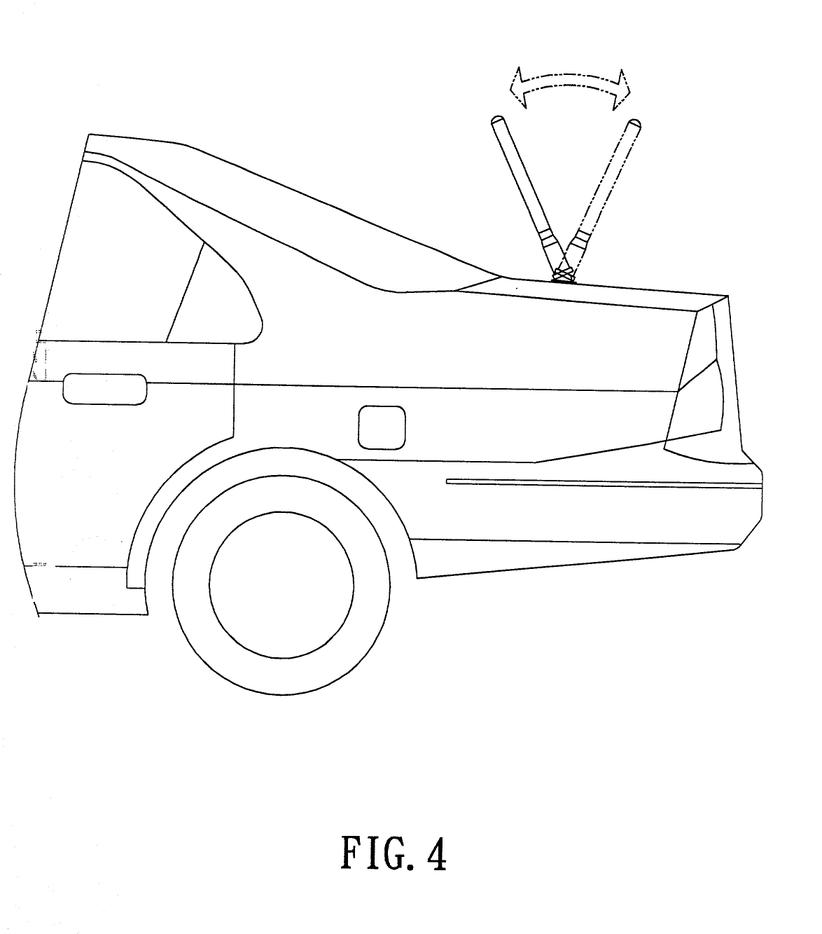

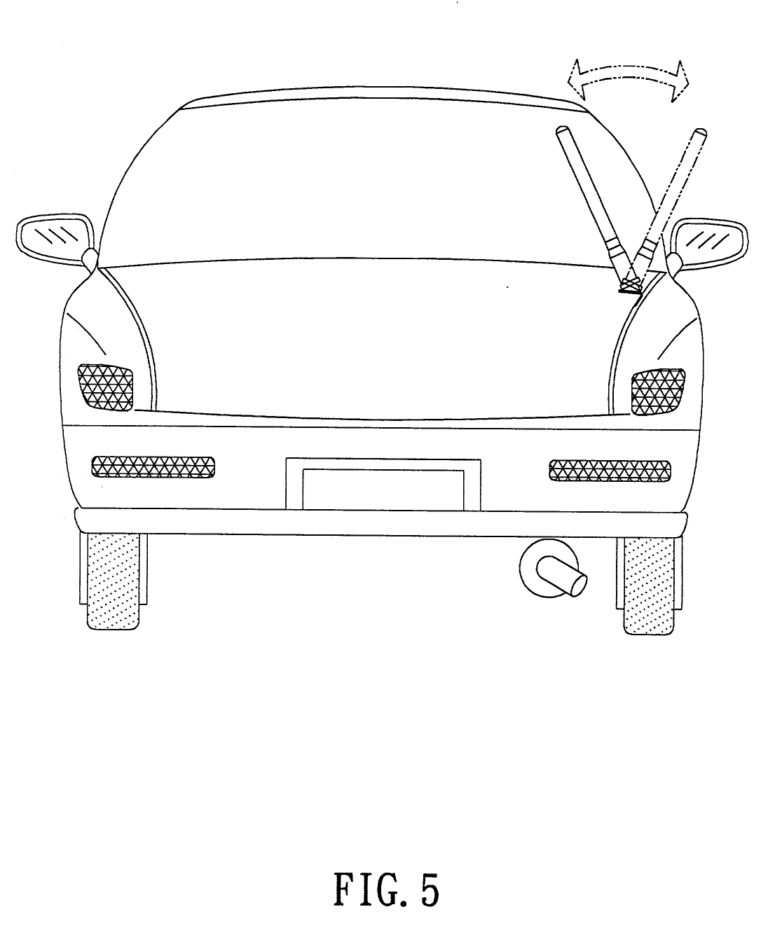

With the above arrangements, the auxiliary light of the present invention may be mounted to any desired position on a body 20 of a car, such as the trunk lid, the hood, etc., as shown in FIG. 3. Moreover, the lamp 12 may be angularly adjusted in its position relative to the fixing seat 11 via the locating member 13, so that the lighting tube 122 may be oriented toward different directions, as shown in FIGS. 4 and 5.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A removable auxiliary light for car, comprising a fixing seat adapted to removably mount on a body of a car, and a lamp being internally provided with at least one light-emitting element and having a light-transmissible lighting tube connected to a top of said fixing seat, such that light emitted from said light-emitting element is diffused via said lighting tube.

2. The removable auxiliary light for car as claimed in claim 1, wherein said fixing seat is removably mounted on the body of the car with means selected from the group consisting of screws, clamping means, and bonding agent.

3. The removable auxiliary light for car as claimed in claim 1, wherein said lamp may be directly coupled with a sidelight, a directional light or a reverse light of the car to function like an extended warning means and an decoration on the car.

4. The removable auxiliary light for car as claimed in claim 1, further comprises a locating member provided between said fixing seat and said lamp for said lamp to stably seated on said locating member; said locating member being so structured that it is turnable over the top of said fixing seat to allow angular adjustment of said lamp and accordingly said lighting tube connected to said lamp relative to said fixing seat.

5. The removable auxiliary light as claimed in claim 1, wherein said lighting tube is colored and/or shines intermittently, depending on actual needs, to achieve warning and decorating effects.
